(19) United States
(12) Patent Application Publication
(10) Pub. No.: US 2008/0233259 A1
(43) Pub. Date: Sep. 25, 2008

(54) Ready-to-Eat Gelatin Noodle and Process for Producing the Same

(75) Inventors: Yoshiyuki Imanishi, Osaka (JP); Toshiaki Sonoda, Osaka (JP); Kazuo Nagao, Osaka (JP); Masafumi Nakano, Osaka (JP)

Correspondence Address: William L. Androlia;Quinn Emanuel Urquhart Oliver & Hedges, LLP, 10th Floor, 865 S. Figueroa Street, Los Angeles, CA, 90007, US

(73) Assignee: Acecook Co., Ltd.

(21) Appl. No.: 10/572,047

(22) PCT Filed: May 31, 2005
(86) PCT No.: PCT/JP2005/009960

§ 371 Date: Mar. 15, 2006

(30) Foreign Application Priority Data
Nov. 19, 2004 (JP) 2004-335718

(51) Int. Cl. A23L 1/0522

(52) U.S. Cl. 426/549

(57) ABSTRACT

A process for producing instant bean-starch vermicelli (harusame) that is capable of suppressing not only dissolution during boiling but also elongation and swell after cooking, and that exhibits appropriate elasticity and gives firm palatability. This instant bean-starch vermicelli is produced from a mixed starch consisting of potato starch and mung bean starch as a raw material. In the mixed starch consisting of potato starch and mung bean starch, the content of potato starch is in the range of 30 to 70 wt. %. 0.25 to 5 wt. % of curdlan is added to the mixed starch. The resultant mixed starch is kneaded with water, and extruded into hot water through a die to thereby obtain linear noodles. The linear noodles are boiled with hot water, washed with water, and cooled. The thus cooled linear noodles are frozen in a freezer, thereafter thawed, cut into given lengths, weighed and dried by means of hot air.

### TECHNICAL FIELD

The present invention relates to ready-to-eat gelatin noodle and a process for producing the same.

### BACKGROUND ART

Proposed as a process for producing ready-to-eat gelatin noodle is a process which comprises the steps of kneading green-gram starch with water; extrusion-molding the thus kneaded green-gram starch through a number of nozzles to lines of green-gram starch; boiling them; washing them with water; freezing them to form rough mass and de-freezing it; and drying it (for example, see Patent Literature 1).

Patent Literature 1 Patent Public Disclosure No. 2001-17105

### DISCLOSURE OF THE INVENTION

### The Problem the Invention Attempts to Solve

However, the above-mentioned ready-to-eat gelatin noodle has problems that the green-gram starch is readily dissolved out during the boiling step and it takes time to return it with boiling water to the original state.

The present invention has been created so as to solve the above problems. It has an object to provide ready-to-eat gelatin noodle and a process for producing the same which adds curdlan into the mixed starch consisting of potato starch and green-gram starch, a starting material of ready-to-eat gelatin noodle, so as to inhibit the dissolution of starch during the boiling step as well as the extension and swell-up caused by boiling water after it has been cooked, thereby obtaining ready-to-eat gelatin noodle which presents proper elastic feeling upon eating it.

### Means for Solving the Problem

The ready-to-eat gelatin noodle of the present invention is characterized in the it is produced from a mixed starch consisting of potato starch and green-gram starch, which contains 30 to 70 wt % of potato starch and 0.25 to 5 wt % of curdlan is added to.

The process for producing ready-to-eat gelatin noodle according to the present invention is characterized in that during the process of producing the ready-to-eat gelatin noodle from a mixed starch consisting of potato starch and green-gram starch, the mixed starch contains 30 to 70 wt % of potato starch and 0.25 to 5 wt % of curdlan is added to the mixed starch.

### EFFECT OF THE INVENTION

It is possible to supplement the disadvantage of taking time so as to return the green-gram starch by boiling water to its original state that the green-gram starch has, with potato starch while keeping the elasticity and smoothness of the green-gram starch owing to the 30 to 70 wt % content of potato starch in the mixed starch. Particularly, with the potato starch contained in the amount of less than 30 wt %, the gelatin noodle cannot restore its original state by boiling water within 3 minutes. On the other hand, with the potato starch content of at least 30%, the gelatin noodle can restore its original state well with boiling water for 3 minutes, However, if it is contained in the amount of more than 70 wt %, the lines formed (hereafter referred to as ‘lines of noodle’ during the previous step stick together during the boiling step, so that they cannot maintain the shape of lines. Besides, when the lines of noodle are hung on a straight bar on freezing them, they are attached to the bar or each other to result in the difficulty of loosening and the readiness of being cut. In addition, after they have been de-frozen, they are loosened with difficulty and cut with readiness. Like that they are not good in the workability on processing the gelatin noodle. However, with the content of potato starch being at least 30 wt % and less than 70 wt %, they are easily formed into lines and hung on the straight bar to result in being loosened well after de-frozen. Thus this content makes the gelatin noodle excellent in processing and workability.

While the gelatin noodle can improve its ability to restore its original state with boiling water so as to meet the requirement for ready-to-eat, by mixing the potato starch with the green-gram starch in the above ratio, the extension and the swell-up after cooking readily occur. However, if 0.25 to 5 wt % of curdlan is added, it swells and acts to increase stickiness, thereby inhibiting the gelatin noodle from extending and swelling up with the boiling water after it has been cooked to result in producing ready-to-eat gelatin noodle which makes us enjoy the smooth elasticity and comfortable chewing.

### BRIEF DESCRIPTION OF THE DRAWINGS

FIG. 1 is a Table Figure showing the evaluation results such as the extension and the swell-up caused by pouring boiling water with the mixing ratio of green-gram starch and potato starch changed.

FIG. 2 is a Table Figure showing the evaluation results such as the extension and the swell-up caused by pouring boiling water, of Examples 1 to 7 as well as those of Comparison Examples 1 to 4.

### MOST PREFERRED EMBODIMENT OF THE INVENTION FOR PUTTING IT INTO PRACTICE

During the process of producing ready-to-eat gelatin noodle according to the present invention, curdlan is added to the mixture of the green-gram starch and the potato starch. At this time, the mixed starch is kneaded with water and the thus kneaded mixed starch (material) is extruded into boiling water through a die to form lines of noodle. The thus formed lines of noodle are boiled with boiling water and are washed with water to cool them. The cooled lines of noodle are hung on a straight bar and frozen in a refrigerator. Subsequently, they are de-frozen, cut to a predetermined length, weighted and then dried with hot air to complete the production of ready-to-eat gelatin noodle.

As for the mixing ratio of potato starch with green-gram starch, if 30 to 70 wt % of potato starch is contained in the mixed starch of potato starch and green-gram starch, it makes the gelatin noodle restore its original state with boiling water well and besides facilitate to form lines and to hung them on the straight bar. In addition, after de-frozen, they are loosened well. Thus this ratio is preferable. With the content of potato starch in the amount of less than 30 wt %, the gelatin noodle cannot return to its original state with boiling water for 3 minutes and therefore is not good in restoring its original state with boiling water. On the other hand, with the amount of more than 70 wt %, the formed lines of noodle stick together during the boiling step as well as upon hanging them on the straight bar at the time of freezing. Besides, they are hardly loosened and readily cut. This is the same after de-freezing them. Thus they are not good in workability on processing them.

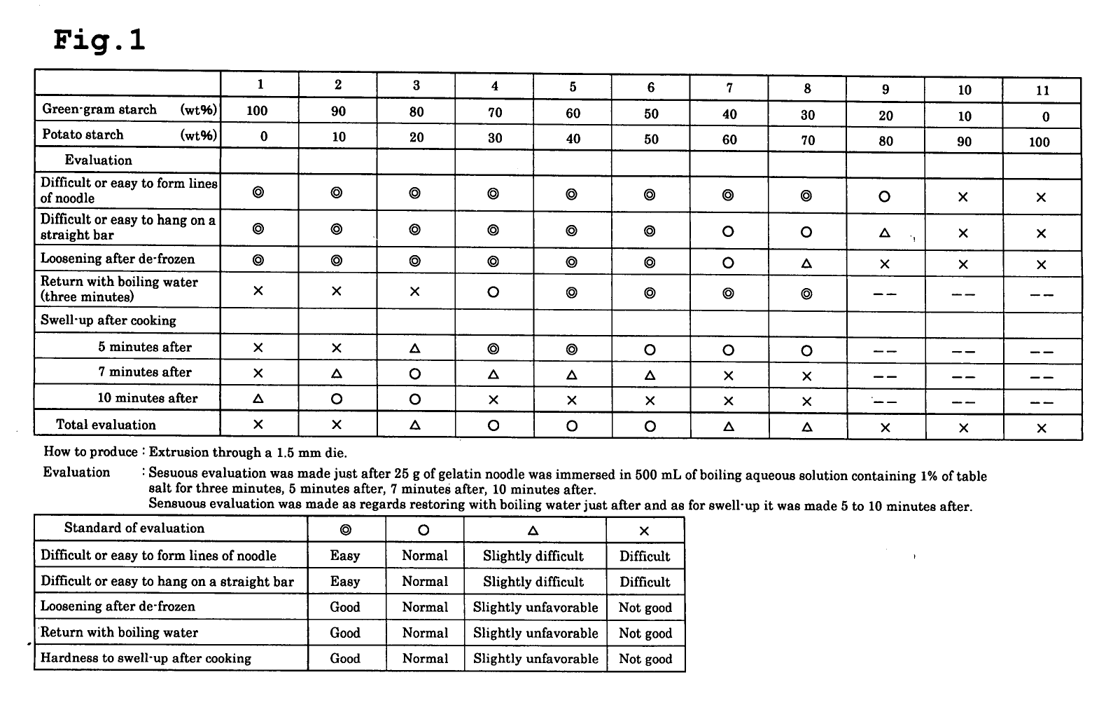

The Table Figure of FIG. 1 shows the evaluation results about the restoring ability and swell-up of the ready-to-eat gelatin noodle with the mixing ratio of green-gram starch and potato starch changed.

The following fact can be seen from this Table Figure.

In the case where not more than 20 wt % of potato starch is contained in the mixed starch consisting of green-gram starch and potato starch, there was obtained no gelatin noodle which restored its original state with boiling water within 3 minutes. On the other hand, with at least 30 wt % content of potato starch, gelatin noodle restored its original state well with boiling water.

In the event that not less than 80 wt % of potato starch is contained, the workability became worse in the aspect of processing the gelatin noodle. What are concretely meant by the processing of gelatin noodle are the sticking of lines of noodle during the boiling step, and the attaching and the dropping of the lines of noodle hung on the straight bar.

Apparently from the Table Figure of FIG. 1, it can be seen that while the gelatin noodle can restore its original state well with boiling water by mixing potato starch with green-gram starch, the extension and the swell-up occur a few minutes after cooking. The noodle packed into a cup is eaten up within 7 minutes in average. But the swell-up has already begun 7 minutes after cooking.

Nevertheless, the addition of curdlan can solve the problem that such swell-up and extension occur. More specifically, if 0.25 to 5 wt %, more preferably 1 to 4 wt % of curdlan is added to the mixed starch of green-gram starch and potato starch, the curdlan acts to increase stickiness, thereby inhibiting the extension and the swell-up after cooking to result in obtaining ready-to-eat gelatin noodle which can make us enjoy its smoothness and elastic chewing. Even if the curdlan is added, with the amount of less than 0.25 wt %, the gelatin noodle extends and swells up 7 minutes after cooking. Further with the amount of more than 5 wt %, the noodle becomes too hard to return to its original state (just 3 minutes after). It takes more than 5 minutes to return it with boiling water to its original state. Thus it is not suitable for the ready-to-eat gelatin noodle.

### EXAMPLES

### Example 1

60 wt % of potato starch was mixed with 40 wt % of green-gram starch to form a mixture, to which 0.25 wt % of curdlan was added. At this time, preliminarily, part (for example 10 wt part) of the mixed starch was heated to make it paste while mixing 100 wt part of water to form a carrier paste. This carrier paste was added to the remaining part of the mixed starch and kneaded by a mixer to form a material. Next, this material was extruded into boiling water through a die of 1.5 mm diameter by an extruder and was molded into lines. Next, the molded lines of noodle were boiled in hot water of 98 degrees C. to 100 degrees C. for about 1 minute and then were taken out to wash and cool them with water. Subsequently, the cooled lines of noodle were hung on a straight bar and frozen in a refrigerator at a temperature of −20 degrees C. overnight. On the next day, they were de-frozen with water and cut to about 15 cm, and weighted. Then they were thrown into a metal framework and dried for 25 minutes with hot air of 80 degrees C. Thus dried ready-to-eat gelatin noodle containing about 10% of moisture was obtained.

As for the curdlan, the “CURDLAN S” of trade name, made by Takeda Kirin Foods Kabushiki Kaisha was used.

### Example 2

Example 2 was conducted in the same manner as Example 1 except that 60 wt % of potato starch was mixed with 40 wt % of green-gram starch to form a mixture, to which 0.5 wt % of curdlan was added.

### Example 3

Example 3 was conducted in the same manner as Example 1 except that 60 wt % of potato starch was mixed with 40 wt % of green-gram starch to form a mixture, to which 1 wt % of curdlan was added.

### Example 4

Example 4 was conducted in the same manner as Example 1 except that 60 wt % of potato starch was mixed with 40 wt % of green-gram starch to form a mixture, to which 2 wt % of curdlan was added.

### Example 5

Example 5 was conducted in the same manner as Example 1 except that 60 wt % of potato starch was mixed with 40 wt % of green-gram starch to form a mixture, to which 3 wt % of curdlan was added.

### Example 6

Example 6 was conducted in the same manner as Example 1 except that 60 wt % of potato starch was mixed with 40 wt % of green-gram starch to form a mixture, to which 4 wt % of curdlan was added.

### Example 7

Example 7 was conducted in the same manner as Example 1 except that 60 wt % of potato starch was mixed with 40 wt % of green-gram starch to form a mixture, to which 5 wt % of curdlan was added.

### Comparison Example 1

Comparison Example 1 was conducted in the same manner as Example 1 except that 60 wt % of potato starch was mixed with 40 wt % of green-gram starch without adding curdlan.

### Comparison Example 2

Comparison Example 2 was conducted in the same manner as Example 1 except that 60 wt % of potato starch was mixed with 40 wt % of green-gram starch to form a mixture, to which 0.1 wt % of curdlan was added.

### Comparison Example 3

Comparison Example 3 was conducted in the same manner as Example 1 except that 60 wt % of potato starch was mixed with 40 wt % of green-gram starch to form a mixture, to which 7.5 wt % of curdlan was added.

### Comparison Example 4

Comparison Example 4 was conducted in the same manner as Example 1 except that 60 wt % of potato starch was mixed with 40 wt % of green-gram starch to form a mixture, to which 10 wt % of curdlan was added.

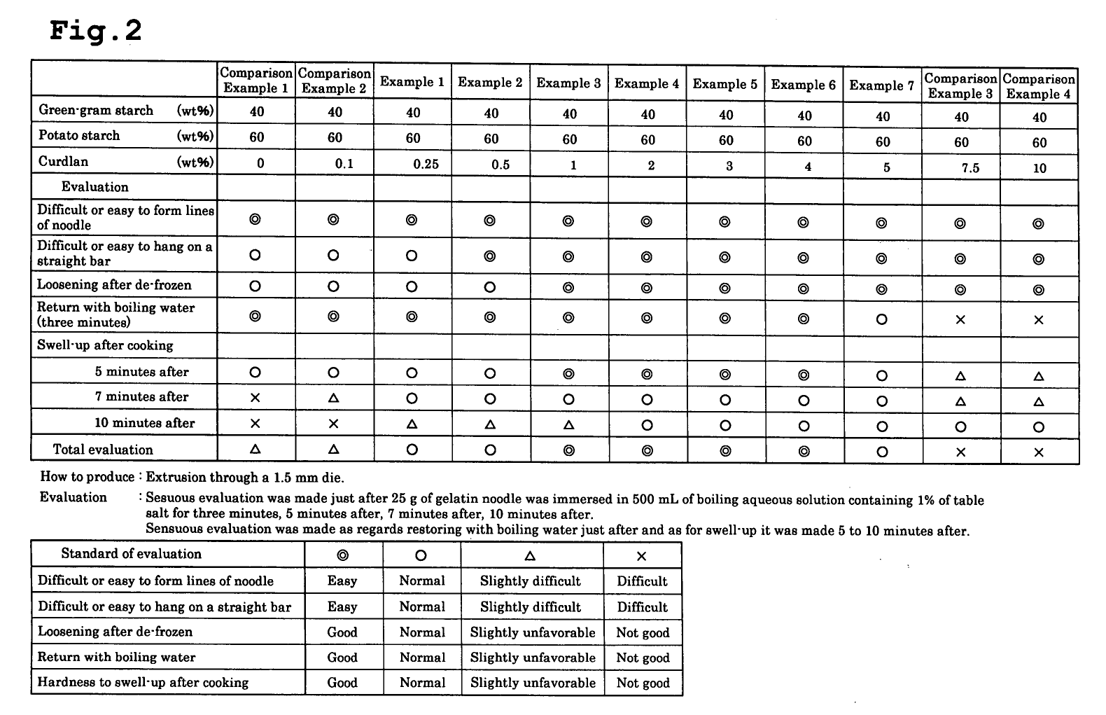

Evaluation results of Examples 1 to 7 are shown in the Table of FIG. 2 as well as those of Comparison Examples 1 to 4. Apparently from this Table Figure, in the case where no curdlan is added to a mixed starch of potato starch and green-gram starch as in Comparison Example 1 or even if the curdlan was added, the amount is less than 0.25 wt % as in Comparison Example 2, the gelatin noodle extends or swells up with boiling water 7 minutes after cooking. Nevertheless, in the event that the curdlan is added in the amount of more than 5 wt % as in Comparison Examples 3 and 4, the gelatin noodle is too hard to restore its original state with boiling water (just 3 minutes after) and it takes more than 5 minutes to return the gelatin noodle with boiling water to its original state. Thus it is not suitable for the ready-to-eat gelatin noodle.

It can be seen that it is possible to obtain ready-to-eat gelatin noodle which returns with boiling water well to its original state (good restoring ability with boiling water) and which is not felt so much that it is extended or swelled up even 7 minutes after cooking, by adding 0.25 to 5 wt %, preferably 1 to 4 wt % of curdlan as in Examples 1 to 7.

1. Ready-to-eat gelatin noodle prepared from a starting material of mixed starch which consists of potato starch and green-gram starch mixed with each other, wherein the mixed starch contains 30 to 70% of potato starch and 0.25 to 5 wt % of curdlan is added to the mixed starch.

2. A process for producing ready-to-eat gelatin noodle from a starting material of mixed starch which consists of potato starch and green-gram starch mixed with each other, wherein the mixed starch contains 30 to 70% of potato starch and 0.25 to 5 wt % of curdlan is added to the mixed starch
